(19) United States
(12) Patent Application Publication
(10) Pub. No.: US 2003/0105932 A1
(43) Pub. Date: Jun. 5, 2003

(54) Emulation of memory clock enable pin and use of chip select for memory power control

(76) Inventors: Howard S. David, Portland, OR (US); Paul G. Close, Portland, OR (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/010,030

(22) Filed: Nov. 30, 2001

(51) Int. Cl. G06F 12/00; G06F 13/00

(52) U.S. Cl. 711/167

(57) ABSTRACT

A method and apparatus for powering down a memory device by deasserting a chip select line for a predetermined number of consecutive clock cycles and for powering up the memory device by asserting the chip select line.

### FIELD OF THE INVENTION

The present invention is related to circuitry used to control the powering up and powering down of memory devices.

### ART BACKGROUND

It has become commonplace for circuitry comprising computer systems to have the capability to be put into a lower power consumption state (otherwise known to those skilled in the art as ‘powering down’ or being ‘powered down’) to reduce electrical power requirements. This is often the case in portable computer systems such as the typical notebook computer, which is often used in a configuration where only limited power is available from a battery. However, there has been increasing interest in incorporating such power saving functionality into non-portable computer systems, such as the typical desktop computer, due to increasing environmental and other concerns, despite the availability of a steady power supply. Powering down the random access memory (RAM) of a computer system has become a focus of attention in efforts to reduce power consumption due to the typically large quantity of electronic components comprising the RAM.

At the same time, continuing demands for increased performance from computer systems, along with the integration of ever more functionality within each integrated circuit comprising a computer system, has brought about the need for increasing numbers of pin connections to be carried by such integrated circuits. As a result, integrated circuit packages supporting ever larger quantities of pins have been devised, but the effort to put ever more pins on such packages very quickly results in packages that are far more expensive for even a small increase in the number of pins. As a result, there is increasing pressure to find ways for integrated circuits to perform the functions and achieve the levels of performance required of them, but to do so while restricting or reducing the number of pins.

A function requiring a large number of pins in a typical computer system is the interface between one or more integrated circuits that create a memory interface and the often numerous memory devices comprising the RAM. Currently, a memory interface in a typical computer system requires a large quantity of pins for the exchange of data, a large quantity of pins to transmit addresses, and numerous other pins for control signals such as chip selects, address strobes, clocks, etc.

FIG. 1 depicts a typical embodiment of prior art memory interface. Memory controller 102 is comprised a memory interface and circuitry to carry out operations with memory devices 112, 114, 116 and 118. This memory interface is comprised of address lines 122, data lines 124, control lines 126 that include a clock signal line, chip select lines 130, and clock enable lines 140. Address lines 122 comprise an address bus used to transmit row, column and/or bank addresses from memory controller 102 to memory devices 112, 114, 116 and 118. Data lines 124 comprise a data bus used to transfer data between memory controller 102 and memory devices 112, 114, 116 and 118. Control lines 126 comprise various connections between memory controller 102 and memory devices 112, 114, 116 and 118 used for various purposes, including coordinating activity on address lines 122 and data lines 124. Chip select lines 130 are comprised of chip select lines 0 through 3 (i.e., CS0# through CS3#), which connect separately to each one of memory devices 112, 114, 116 and 118.

Also, in a manner similar to chip select lines 130, clock enable lines 140 are comprised of clock enable lines 0 through 3 (i.e., CKE0 through CKE3), which also connect separately to each one of memory devices 112, 114, 116 and 118. Each clock enable line comprising clock enables lines 140 can be used to selectively power up or power down whichever one of memory devices 112, 114, 116 or 118 to which it is connected, thereby allowing each memory device to be individually powered up or powered down by memory controller 102.

Given the large number of pins required to create a memory interface, it would be highly desirable to find some way in which the quantity of pins may be reduced without compromising functionality, including the capability to power down, or performance.

### BRIEF DESCRIPTION OF THE DRAWINGS

The objects, features, and advantages of the present invention will be apparent to one skilled in the art in view of the following detailed description in which:

FIG. 1 is a block diagram of one embodiment of the prior art.

FIG. 2 is a block diagram of one embodiment of the present invention.

FIG. 3 depicts a pair of registers comprising a specific implementation of the embodiment depicted in FIG. 2.

FIG. 4 is a timing diagram of one embodiment of the present invention.

FIG. 5 is a timing diagram of another embodiment of the present invention.

FIG. 6 is a block diagram of another embodiment of the present invention.

### DETAILED DESCRIPTION

In the following description, for purposes of explanation, numerous details are set forth in order to provide a thorough understanding of the present invention. However, it will be apparent to one skilled in the art that these specific details are not required in order to practice the present invention.

The present invention concerns using circuitry to bring about the powering down and powering up of memory devices using a memory interface with a reduced pin count. Specifically, an embodiment of the present invention concerns powering down and powering up single data rate (SDR) and double data rate (DDR) synchronous dynamic random access memory (SDRAM) without the use of clock enable pins. However, although the present invention is discussed in reference to SDR and DDR memory devices, it is also applicable to other dynamic memory devices using other interfaces or protocols, as well as being applicable to memory devices based on other technologies, including but not limited to SRAM, ROM, EEPROM and flash memory. Furthermore, the memory devices discussed herein may take the form of individual integrated circuits, multi-chip modules, miniature circuit boards to which one or more integrated circuits are attached (as in the case of widely known SIMM or DIMM modules), as well as other various forms.

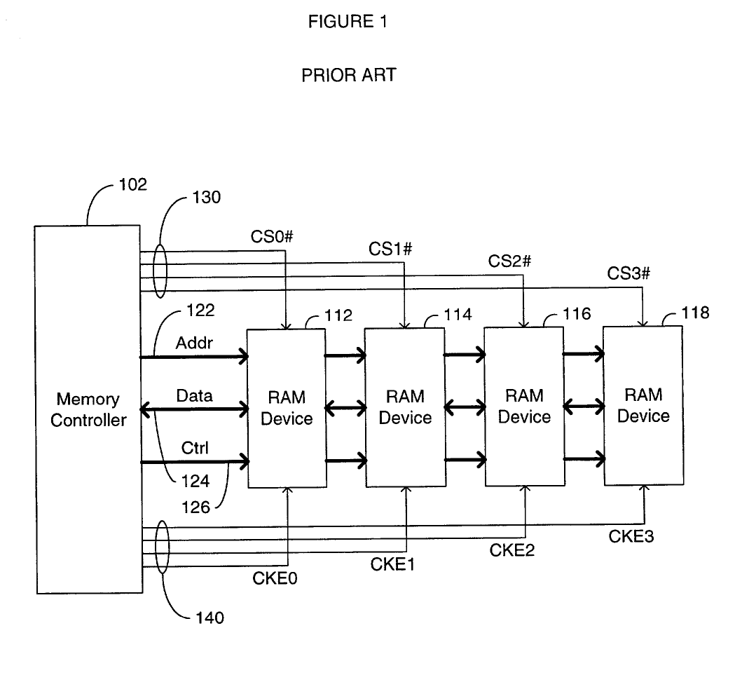

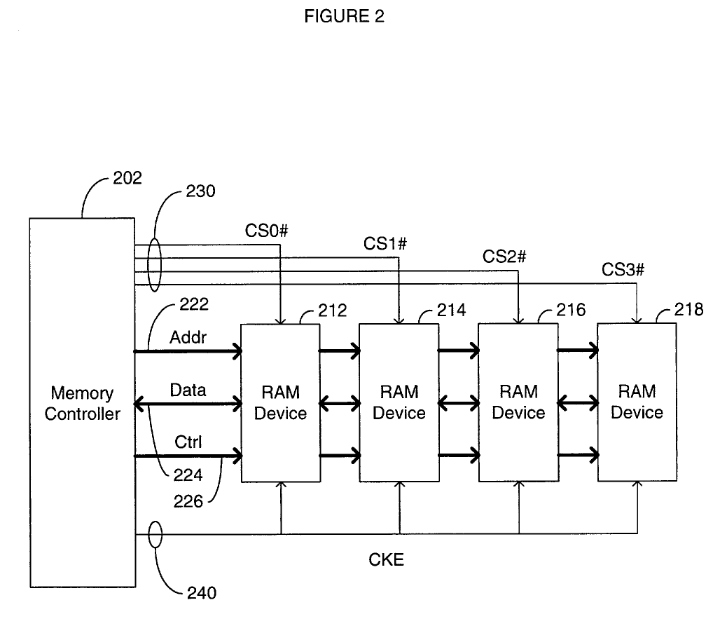

FIG. 2 depicts a block diagram of one embodiment of the present invention. Memory controller 202 is comprised of circuitry to carry out operations with memory devices and provides a memory interface to memory devices 212, 214, 216 and 218 that allows memory controller 202 to carry out operations with memory devices 212, 214, 216 and 218. This memory interface is comprised of address lines 222, data lines 224, control lines 226 that include a clock signal line, chip select lines 230, and clock enable line 240. In a manner generally corresponding to the prior art depicted in FIG. 1, address lines 222 comprise an address bus, data lines 224 comprise a data bus, and control lines 226 comprise various connections between memory controller 202 and memory devices 212, 214, 216 and 218 used to control or coordinate activities occurring between memory controller 202 and memory devices 212, 214, 216 and 218. Also in a manner generally corresponding to FIG. 1, chip select lines 230 are comprised of four chip select lines (CS0# through CS3#) that connect separately to each one of memory devices 212, 214, 216 and 218.

However, unlike clock enable lines 140 of the prior art depicted in FIG. 1, clock enable line 240 of the embodiment of the invention depicted in FIG. 2 is a single clock enable line (CKE) that connects to all of memory devices 212, 214, 216 and 218. This reduces the number of pins required to be used on the packaging of memory controller 202 to supply clock enables lines 240. The single clock enable line that comprises clock enable line 240 can be used by memory controller 202 to power up or power down all of memory devices 212, 214, 216 and 218 in unison. To effect the powering up and power down of individual ones of memory devices 212, 214, 216 and 218, a combination of timed circumstances and individual chip select lines comprising chip select lines 230 are used by memory controller 202, as will now be described. Also, as those skilled in the art will realize, this same way to effect powering up and down of individual ones of memory devices 212, 214, 216 and 218 that will now be described may also be used to effect the powering up or down all of these same memory devices in unison, thereby making possible a variation of the embodiment depicted in FIG. 2 that would entirely lack clock enable line 240.

In the embodiment depicted in FIG. 2, at least one of memory devices 212, 214, 216 or 218 will power down when the chip select line to which the given memory device is connected is deasserted (i.e., caused to become inactive) by memory controller 202 for a predetermined number of consecutive clock cycles. Furthermore, this same memory device will cease being in powered down state (i.e., will ‘power up’) when the chip select line to which this memory device is connected is once again asserted.

A variation of this embodiment may be implemented to conform with the timing and signaling requirements of widely used SDRAM memory interfaces, whether in the form of SDR or DDR variations. In such an implementation, the clock signal would be transmitted from memory controller 202 to memory devices 212, 214, 216 and 218 via a pair of clock signal lines of opposite polarity (often labeled as “CK” and “CK#”), as opposed to a single clock signal line, thereby providing a differential signal pair for the transmission of a clock signal.

Also, in a variation of this embodiment, one or more bits in one or more control registers within at least one of memory devices 212, 214, 216 or 218 may be used to enable or disable the ability of that memory device to power down when a chip select line connected to that memory device has been deasserted for a predetermined number of consecutive clock cycles. In another variation, one or more of such bits may be used to set the predetermined number of consecutive clock cycles.

As those skilled in the art will recognize, address lines 222, control lines 226, chip select lines 230, and clock enable line 240 are often driven exclusively by memory controller 202. Therefore, as discussed, it would be memory controller 202 that would operate one or more of chip select lines 230 in such a way as to cause one or more of memory devices 212, 214, 216 and 218 to power down and/or power up. However, other embodiments are possible in which one or more of chip select lines 230 are driven by one or more other devices (not shown) either in place of or in addition to memory controller 202.

Although the embodiment depicted in FIG. 2 makes use of chip select lines 230 to bring about the individual powering up and powering down of at least one of memory devices 212, 214, 216 and/or 218, it will be understood by those skilled in the art that any signal line performing the function of distinguishing between memory devices for performing operations or for transferring commands and/or data may be used, whether specifically identified as a ‘chip select’ or by other nomenclature.

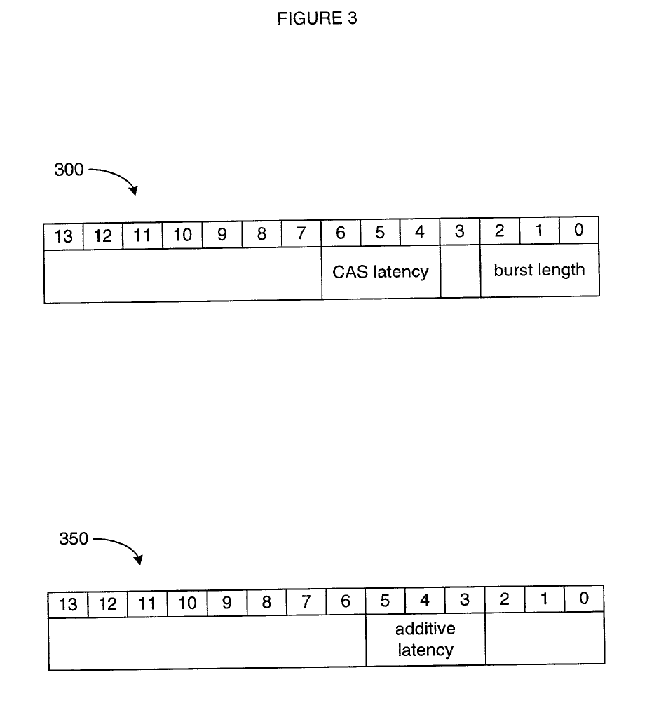

FIG. 3 depicts a specific implementation of bits in registers comprising a specific implementation of the embodiment depicted in FIG. 2. The registers in this specific implementation could be directed for use with the timing and/or signaling requirements of widely used SDRAM interfaces, or alternatively, for use with other memory interfaces having similar states or phases in address, command and/or data transfer cycles. FIG. 3 depicts a pair of registers comprising at least part of the registers within a memory device (not shown) in which at least a portion of the data storage locations within the memory device are organized in at least a single two-dimensional array of rows and columns. Both mode register 300 and extended mode register 350 are comprised of 14 bits (numbered 0 through 13). Bits 4-6 of mode register 300 are used to set the column address strobe (CAS) latency, i.e., the maximum number of clock cycles that are allowed to take place between the receipt of a read command and when read data must be available from the memory device. Bits 0-2 of mode register 300 are used to set the burst length, i.e., the maximum number of column locations that can be accessed in a given read or write activity. Bits 3-5 of extended mode register 350 are used to set the additive latency, i.e., the additional number of clock cycles required by the memory device from the time a read or write command is received at the inputs to the memory device to the time the read or write command is actually executed by the memory device.

Although the aforedescribed bits of mode register 300 and extended mode register 350 are used to set various parameters, as just discussed, in this specific implementation, the parameters set by these same bits are also used as inputs to an equation used to derive the predetermined number of consecutive clock cycles for a deasserted chip select line will cause the memory device to power down. Though various equations using varying combinations of these parameters are possible, in this specific implementation one specific equation derives the predetermined number of consecutive clock cycles as being the sum of the CAS latency set by bits 4-6 of mode register 300, the additive latency set by bits 3-5 of extended mode register 350, and half of the burst length set by bits 0-2 of mode register 300. By way of example, if the CAS latency is set to 5, the additive latency set to 0, and the burst length set to 4, then the predetermined number of consecutive clock cycles would be the sum of 5, 0 and half of 4, i.e., the sum would be 7 consecutive clock cycles. This would mean that a chip select line being deasserted for 7 consecutive clock cycles would result in the memory device powering down.

Alternatives to the specific embodiment depicted in FIG. 3 may use differing arrangements, quantities or combinations of bits and/or registers to set differing combinations of the CAS latency, additive latency and/or burst length parameters. Other alternatives may use one or more other parameters in addition to or in substitution of CAS latency, additive latency and/or burst length. Still other alternatives may not use such parameters, at all, to derive a predetermined number of consecutive clock cycles, but may, instead, use one or more bits and/or registers to directly set the predetermined number of consecutive clock cycles.

Though not shown in FIG. 3, an additional bit or bits may be used in either one of mode register 300 or extended mode register 350, and/or in still another register (not shown), to enable or disable powering down of the memory device, as described, after a predetermined number of consecutive clock cycles have passed with a deasserted chip select line. Alternatively, the enabling or disabling of this powering down may be made a part of the functionality of one of the above sets of aforedescribed bits used to set parameters used either in deriving or directly setting the predetermined number of consecutive clock cycles relied upon for causing the memory device to power down. Depending on the design of a specific memory device, the enabling or disabling powering down of the memory device, as described, after a predetermined number of consecutive clock cycles have passed with a deasserted chip select line, may entail causing an input or input buffer for receiving the chip select line to remain active at a time when it would otherwise normally be powered down along with other portions of the memory device.

Various embodiments or variations of the above embodiments may use the occurrence or lack of occurrence of one or more specific forms of activity or operations on the address, data and/or control lines as part of the trigger for causing a memory device to power down. Various embodiments may additionally employ one or more bits in one or more registers to allow these one or more specific forms of activity or operations to be programmable, with perhaps, some specific subset of forms of possible activity or operations being relied upon by default unless the values of such bits in such registers are reprogrammed subsequent to the memory device being supplied with power, being initialized or being reset. In still other various embodiments or variations of the above embodiments, the transfer and/or execution of the last specific form of activity or operation (such as the last specific command) taking place before a chip select line becomes deasserted may influence the predetermined number of consecutive clock cycles, either directly or through one of the parameters of an equation used to derive the predetermined number of consecutive clock cycles. For example, a memory device might stay powered up for a larger number of predetermined consecutive clock cycles of inactivity on a chip select line after a write command as opposed to a read command occurring just before the inactivity on the chip select line begins.

In a number of the aforedescribed embodiments and variations of embodiments, bits in registers are used either to enable or disable, or to control the timing of when a memory device, such as a DRAM integrated circuit, would power down. However, in these various embodiments or variations of embodiments, such enabling/disabling or setting of parameters/timing may also be effected by tying one or more of the pins of the package of a memory device to a high or low voltage level through a resistor or other means, and arranging for the memory device to read the voltage level of such pins at the time power is supplied to the memory device, at initialization or reset of the memory device, and/or at other specific times. This tying high or low of pins may be implemented to be the only way to do such enabling/disabling or setting of parameters/timings, or this tying high or low of pins may be used in conjunction with bits in registers such that the tying high/low of pins provides the default settings of such bits in registers which may or may not be overridden at some later time.

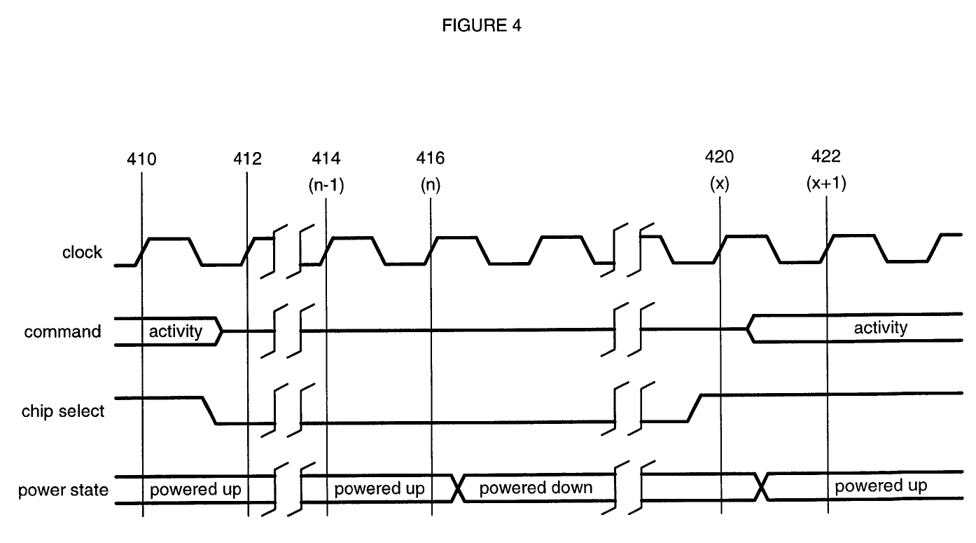

FIG. 4 is a timing diagram of one embodiment of the present invention. A memory device (not shown) receives a clock, one or more command lines and a chip select line, all of which are depicted in FIG. 4. As depicted in FIG. 4, the memory device samples the activity on the chip select line and the command lines at each rising edge of the clock, including at each of times 410, 412, 414, 416, 420 and 422. As those skilled in the art would recognize, this sampling at the rising edge of each clock cycle provides regular time periods between each rising edge where the state of the chip select line and/or the command lines may be changed with sufficient time to stabilize before the next sampling. However, as those skilled in the art will also recognize, performing sampling at the rising edge of each clock cycle is not necessary to practice the present invention. For example, sampling could be carried out at points of a clock cycle, or the receipt and/or latching of the chip select line and/or the command lines could take place without being synchronized to a clock.

At time 410, the memory device is powered up and the chip select line is asserted (i.e., made active). However, by time 412, where the chip select line and the command lines are next sampled, at least the chip select line has been deasserted (i.e., caused to become inactive). It may be that the command lines also ceased to be active, at least to the extent that there are no more commands directed at the memory device, between times 410 and 412, as shown. However, it may also be the case that the command lines ceased to be active at a time prior to time 410.

By time 414, where the memory device is again sampling the chip select line and the command lines, one less than a predetermined number of consecutive clock cycles, i.e., n−1 consecutive clock cycles, have passed with the chip select line deasserted. At time 416, the predetermined number of consecutive clock cycles, i.e., n consecutive clock cycles, have occurred with no activity on the chip select line (i.e., no assertion of the chip select line), and so the memory device powers down after time 416.

The memory device remains powered down, following time 416. However, prior to time 420, the chip select line is asserted, again. Depending upon the characteristics of the memory device, the memory device may power up shortly after time 420, before the next rising edge of the clock at time 422, i.e., within only one clock from time 420, or x+1 clocks. However, the memory device may require more time to power up, and in some implementations, this may require multiple clocks following time 420, perhaps as long as would be required to reach x+6 clocks (not shown). Also, depending on the characteristics of the memory device, it may be possible for inputs and/or input buffers within the memory device to become active quickly enough to allow a command to be received substantially concurrently with the memory device being powered up, as shown. However, the memory device may require additional time to pass, perhaps one or more clock periods, from the time at which the memory device is powered up, until the memory device is able to receive a command. Furthermore, beyond whatever time may be required before the memory device is able to receive a command, the memory device may require still more time, perhaps one or more additional clock cycles, before the memory device is able to execute a command.

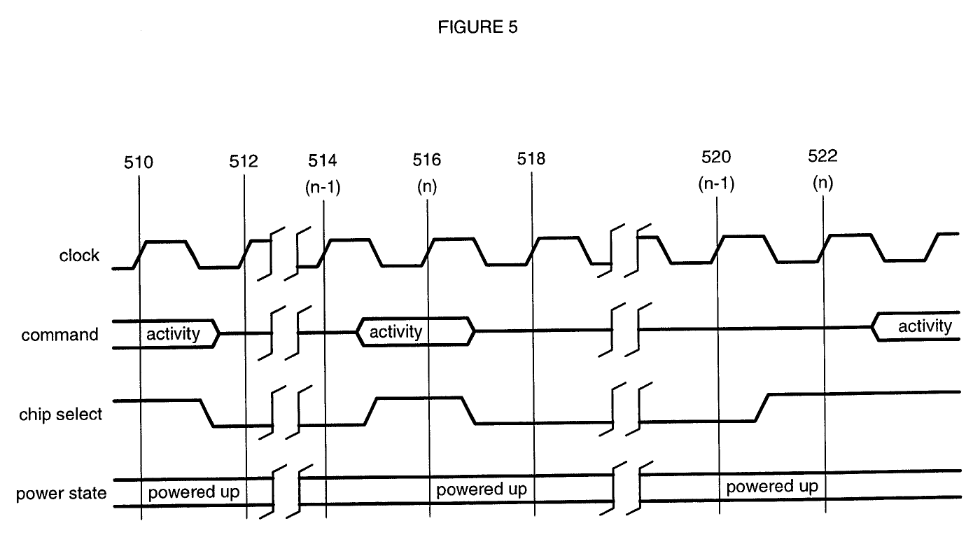

FIG. 5 is a timing diagram of another embodiment of the present invention. In a manner generally corresponding to FIG. 4, a memory device (not shown) receives a clock, one or more command lines and a chip select line, all of which are depicted in FIG. 5. As was the case with the embodiment depicted in FIG. 4, the memory device samples the activity on the chip select line and the command lines at each rising edge of the clock, including at each of times 510, 512, 514, 516, 520 and 522. However, as discussed with reference to the embodiment of FIG. 4, the embodiment in FIG. 5 may carry out sampling at different times and/or in a manner that is not synchronized to a clock.

At time 510, the memory device is powered up and the chip select line is asserted. However, by time 512, where the chip select line and the command lines are next sampled, at least the chip select line has become inactive, i.e., has been deasserted. It may be that the command lines also ceased to be active, at least to the extent that there are no more commands directed at the memory device, between times 510 and 512, as shown. However, it may also be the case that the command lines ceased to be active at a time prior to time 510.

By time 514, where the memory device is again sampling the chip select line and the command lines, one less than a predetermined number of consecutive clock cycles, i.e., n−1 consecutive clock cycles, have occurred. At time 516, the predetermined number of consecutive clock cycles, i.e., n consecutive clock cycles, have occurred, and so the memory device would power down after time 516 had the chip select line remained deasserted since before time 512. However, prior to time 516, the chip select line is asserted, thereby causing the memory device to not power down, i.e., “keep awake.” It may be that the command lines also become active (i.e., activity has been restored to the command lines) prior to time 516, as shown, either with a command to perform an operation involving the memory device, or with a “dummy” or “no-op” command (also commonly referred to as a “nop” command). For example, in the case of a memory device with an interface and an organization of memory storage locations conforming to the typical requirements of an SDRAM device, a write command with auto-precharge to a given bank within the memory device may be carried out as the last activity on the command lines before time 512, followed by an activate command to the same bank during time 516 to keep the memory device from powering down.

By time 518, at least the chip select line has returned to being deasserted. It may be that the command lines also cease to be active prior to time 518, as shown. By time 520, one less than the predetermined number of consecutive clock cycles, i.e., n−1 consecutive clock cycles, have occurred with the chip select line being deasserted, again. At time 522, the predetermined number of consecutive clock cycles (n consecutive clock cycles) have occurred, and so, as before, the memory device would power down after time 522 had the chip select line remained deasserted since before time 518. However, prior to time 522, the chip select line is asserted, thereby again causing the memory device to not power down. Depending on the characteristics of the memory device, it may be possible for inputs and/or input buffers within the memory device to become active quickly enough to allow a command (from at least one command line on which activity has been restored) to be received substantially concurrently with the memory device being powered up. However, the memory device may require additional time to pass, perhaps one or more clock periods, from the time at which the memory device is powered up, until the memory device is able to receive a command, as shown. Furthermore, beyond whatever time may be required before the memory device is able to receive a command, the memory device may require still more time, perhaps one or more additional clock cycles, before the memory device is able to execute a command.

In the embodiment depicted in FIG. 5, at least the chip select line is asserted after having been deasserted for n−1 consecutive clock cycles on two occasions. However, as will be clear to those skilled in the art, FIG. 5, depicts a scenario of activity on at least the chip select line wherein the longest possible periods of time are allowed to pass before activity needed to prevent the memory device from powering down takes place. It may be that times 514 and 516 occur earlier than n−1 and n consecutive clock cycles, respectively, after time 512. Similarly, it may be that times 520 and 522 occur earlier than n−1 and n consecutive clock cycles, respectively, after time 518.

The embodiments depicted in FIGS. 4 and 5 could be implementation intended to be compatible with the timing requirements of a typical SDRAM memory interface. However, as those skilled in the art will recognize, this embodiment could be implemented in a form intended to fit other forms of memory interface. Specifically, signals received by the memory device or transitions between states of the memory device may or may not be synchronized to a clock.

As those skilled in the art will recognize, the clock, one or more command lines and the chip select line received by the memory device of the above discussion concerning FIGS. 4 and 5 are often driven exclusively by a memory controller (also not shown). Therefore, it would be the memory controller that would operate the chip select line in such a way as to cause the memory device to power down and/or power up. Also, it would be the memory controller that would provide the activity on the command lines, such as the transfer of commands to cause operations involving the memory device to be performed by transmitting commands on the command lines for the memory device to receive. However, other embodiments are possible in which the chip select line and/or the command lines are driven by one or more other devices (not shown) either in place of or in addition to the memory controller.

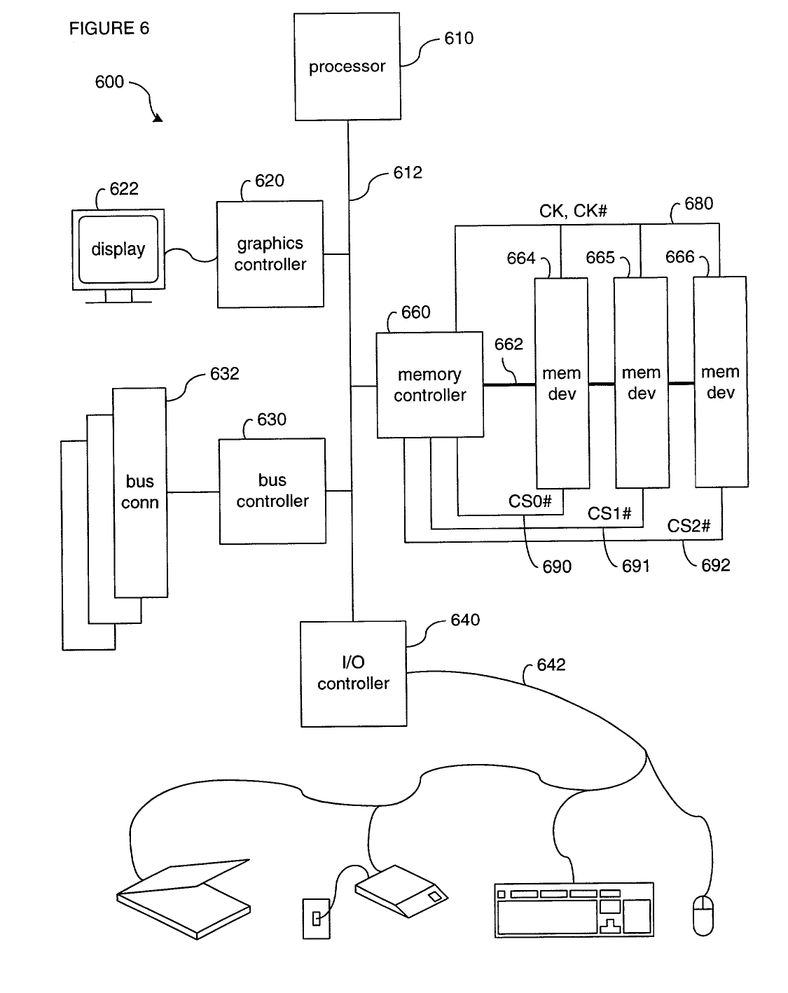

FIG. 6 is a block diagram of another embodiment of the present invention. Computer system 600 is comprised of processor 610, to which graphics controller 620, bus controller 630, I/O controller 640 and memory controller 660 are all coupled via bus 612. In turn, graphics controller 620 is further coupled to display 622, bus controller 630 is further coupled to bus connectors 632, I/O controller 640 is further coupled to a plurality of I/O devices via serial bus 642, and memory controller 660 is coupled to memory devices 664-666.

The coupling of memory controller 660 to memory devices 664-666 is via a memory interface comprised of clock signal lines 680, chip select lines 690-692, and additional signals comprising bus 662, that may include address, control and/or data lines. Memory controller 660 is comprised of circuitry to carry out operations on memory devices 664-666, such as writing data to and reading data from storage locations within one or more of memory devices 664-666. Memory controller 660 synchronizes at least some of the signaling taking place on chip select lines 690-692 and bus 662 with clock signal lines 680, which may be comprised of a differential pair of clock signal lines that may be labeled CK and CK#, as shown in FIG. 6. Memory controller 660 distinguishes which of memory devices 664, 665 and 666 are to be involved in which operations via chip select lines 690, 691 and 692 that are separately coupled to each of memory devices 664, 665 and 666.

Memory controller 660 also powers up and powers down memory devices 664-666 using chip select lines 690-692, respectively. At some earlier time, memory devices 664-666 are each programmed or otherwise configured to power down after the corresponding chip select line to which each of memory devices 664-666 are coupled has been deasserted for a predetermined number of consecutive cycles of the clock transmitted by memory controller 660 to memory devices 664-666 via clock signal lines 680. After powering down, the return of activity to the corresponding chip select line will cause each of memory devices 664-666 to power up. In this way, memory controller 660 may use chip select lines 690-692 to reduce the overall power consumption of computer system 600 by allowing inactivity on one or more of chip select lines 690-692 to signal memory devices 664-666 to power down.

Similarly, memory controller 660 may also prevent the undesired powering down of memory devices 664-666 using chip select lines 690-692, respectively. Memory controller 660 may prevent one or more of memory device 664-666 from powering down as a result of inactivity on the corresponding one of chip select lines 690-692 by asserting that chip select line (i.e., causing activity to occur on that chips select line) before the predetermined number of consecutive cycles of the clock transmitted via clock signal lines 680 has occurred.

Although computer system 600 is depicted as having a discrete memory controller, i.e., memory controller 660, other embodiments of computer system 600 may distribute the functions performed by memory controller 660 among other devices comprising computer 600. By way of example, it may be that different portions of the memory interface to memory devices 664-666 are provided by different devices such that the clock signal transmitted via clock signal lines 680 is provided by one device, while a different device controls activity on chip select lines 690-692.

Furthermore, in one variation of computer system 600, the memory interface to memory devices 664-666 conforms to the timing and/or signaling requirements of widely used SDRAM interfaces, or alternatively, to the timing and/or signaling requirements of other memory interfaces having similar states or phases in address, command and/or data transfer cycles. In such a variation, a clock enable line between memory controller 660 and at least one of memory devices 664-666 that would otherwise be used to power down such memory devices may be entirely eliminated in favor using the present invention. In other words, although memory devices 664-666 may possess an input meant to be coupled to a clock enable line or other signal that could be used to power up or down at least one memory devices 664-666, this input on at least one of memory devices 664-666 is tied off as by either coupling it to a high or low voltage source, or by leaving the input entirely disconnected.

The invention has been described in conjunction with the preferred embodiment. It is evident that numerous alternatives, modifications, variations and uses will be apparent to those skilled in the art in light of the foregoing description. Although the invention has been discussed repeatedly as being used in conjunction with SDRAM memory devices, it will be understood by those skilled in the art that the present invention may be practiced in conjunction with other types of memory devices, including SRAM, other types of DRAM, ROM, EEPROM, flash and still other types. Furthermore, although the example embodiments of the present invention are described in the context of the powering down of memory devices, the present invention is applicable to the powering down of other forms of circuitry.

What is claimed is:

1. A method comprising:
setting a predetermined number of consecutive clock cycles to occur on a clock signal line;
deasserting a chip select for the predetermined number of consecutive clock cycles;
powering down a memory device in response to the deasserting of the chip select line for the predetermined number of clock cycles;
asserting the chip select line; and
powering up the memory device in response to the asserting of the chip select line.

2. The method of claim 1, wherein the setting of a predetermined number of consecutive clock cycles comprises setting at least one bit in at least one register of the memory device.

3. The method of claim 2, wherein the at least one bit in at least one register of the memory device is a bit used in setting at least one timing parameter of the memory device.

4. The method of claim 1, wherein the asserting and the deasserting of the chip select line occur in synchronization with a phase of clock cycles occurring on the clock signal line.

5. The method of claim 1, further comprising ceasing activity on at least one command line prior to deasserting the chip select line, and restoring activity on the at least one command line after asserting the chip select line.

6. The method of claim 1, further comprising preventing the memory device from powering down by asserting the chip select line before the predetermined number of consecutive clock cycles occurs since the chip select line was last asserted.

7. A memory controller comprising:
circuitry to carry out operations with a memory device; and
an interface that couples the circuitry to a memory device, the interface being comprised of a clock signal line and a chip select line, the chip select line being used by the memory controller to power down the memory device by deasserting the chip select line for a predetermined number of consecutive clock cycles occurring on the clock signal line, and to power up the memory device by asserting the chip select line.

8. The memory controller of claim 7, wherein the chip select line is further used by the memory controller to prevent the memory device from powering down by asserting the chip select line before the predetermined number of consecutive clock cycles has occurred since the chip select line was last asserted.

9. The memory controller of claim 7, wherein the memory controller asserts and deasserts the chip select line in synchronization with a phase of clock cycles occurring on the clock signal line.

10. The memory controller of claim 7, wherein the memory controller further ceases activity on at least one command line of the memory interface prior to deasserting the chip select line, and restores activity on the at least one command line after asserting the chip select line.

11. The memory controller of claim 7, wherein the memory controller sets the predetermined number of consecutive clock cycles by programming at least one bit in a register in the memory device.

12. The memory controller of claim 7, wherein the clock signal line is comprised of a pair of signal lines of opposing polarity transmitting a differential clock signal.

13. A memory device comprising:
a plurality of storage locations;
an interface to a memory controller comprised of a clock signal line and a chip select line, where the memory device powers down if the chip select line is deasserted for a predetermined number of consecutive clock cycles occurring on the clock signal line, and where the memory device powers up if the chip select line is asserted.

14. The memory device of claim 13, wherein the memory device can be prevented from powering down by asserting the chip select line before the predetermined number of consecutive clock cycles has occurred since the chip select line was last asserted.

15. The memory device of claim 13, wherein the memory device samples the chip select line in synchronization with a phase of clock cycles occurring on the clock signal line to determine if the chip select line is being asserted.

16. The memory device of claim 13, further comprising at least one bit in at least one register that allows the predetermined number of consecutive clock cycles to be programmed.

17. A computer system comprising:
a processor;
a memory device;
an interface serving to couple the processor to the memory device, the interface being comprised of a clock signal line and a chip select line, the chip select line being used to power down the memory device by deasserting the chip select line for a predetermined number of consecutive clock cycles occurring on the clock signal line, and to power up the memory device by asserting the chip select line.

18. The computer system of claim 17, wherein the chip select line is further used to prevent the memory device from powering down by asserting the chip select line before the predetermined number of consecutive clock cycles has occurred since the chip select line was last asserted.

19. The computer system of claim 17, wherein the chip select line is asserted and deasserted in synchronization with a phase of clock cycles occurring on the clock signal line.

20. The computer system of claim 17, wherein activity ceases on at least one command line of the memory interface prior to deasserting the chip select line, and activity is restored on the at least one command line after asserting the chip select line.

21. The computer system of claim 17, wherein the predetermined number of consecutive clock cycles is set by programming at least one bit in a register in the memory device.

22. The computer system of claim 21, wherein the at least one bit in a register of the memory device is a bit used in setting at least one timing parameter of the memory device.

23. The computer system of claim 17, wherein the clock signal line is comprised of a pair of signal lines of opposing polarity transmitting a differential clock signal.

24. The computer system of claim 17, wherein the memory device comprises an input that allows the memory device to be powered down and powered up that is tied off.

25. A computer-readable medium containing a sequence of instructions, which when executed by a processor causes the processor to power down a memory device by deasserting a chip select line of a memory interface that serves to couple the processor to the memory device for a predetermined number of consecutive clock cycles occurring on a clock signal line of the memory interface, and to power up the memory device by asserting the chip select line.

26. The computer-readable medium of claim 25, wherein the chip select line is further used to prevent the memory device from powering down by asserting the chip select line before the predetermined number of consecutive clock cycles occurs since the chip select line was last asserted.

27. The computer-readable medium of claim 25, wherein the chip select line is asserted and deasserted in synchronization with a phase of clock cycles occurring on the clock signal line.

28. The computer-readable medium of claim 25, wherein activity is ceased on at least one command line of the memory interface prior to deasserting the chip select line, and activity is restored to the at least one command line after the chip select line is asserted.

29. The computer-readable medium of claim 25, wherein the predetermined number of consecutive clock cycles is set by programming at least one bit in a register in the memory device.
